(19) United States
(12) Patent Application Publication
(10) Pub. No.: US 2013/0028668 A1
(43) Pub. Date: Jan. 31, 2013

(54) METHOD AND APPARATUS IN A PNEUMATIC MATERIAL CONVEYING SYSTEM

(71) Applicants: Jan Montonen, Helsinki (FI); Daniel Seere, Vantaa (FI); Göran Sundholm, Tuusula (FI)

(72) Inventors: Jan Montonen, Helsinki (FI); Daniel Seere, Vantaa (FI); Göran Sundholm, Tuusula (FI)

(73) Assignee: MARICAP OY, Vantaa (FI)

(21) Appl. No.: 13/579,608

(22) PCT Filed: Feb. 14, 2011
(86) PCT No.: PCT/FI2011/050132

§ 371 Date: Aug. 17, 2012

(30) Foreign Application Priority Data
Feb. 18, 2010 (FI) 20105160

(51) Int. Cl. B65F 5/00

(52) U.S. Cl. 406/121

(57) ABSTRACT

Method in a pneumatic material conveying system, such as in a waste conveying system, which conveying system comprises at least one input point (1) of material, more particularly of waste material, a material conveying pipe (2, 3), which can be connected to an input point (1), and a separating device (4), in which the material to be transferred is separated from the conveying air, and also means (5) for achieving a pressure difference in the conveying pipe (2, 3) at least during transfer of material. The actuator (12) of the valve means (11, 300, 400) arranged between an input point (1) and the conveying piping (2, 3) is driven and/or controlled with water to be conducted from the water mains network (22).

### BACKGROUND OF THE INVENTION

The object of the invention is a method as defined in the preamble of claim 1.

Another object of the invention is an apparatus as defined in the preamble of claim 12.

The invention relates generally to pneumatic material conveying systems, such as to partial-vacuum conveying systems, more particularly to the collection and conveying of wastes, such as to the conveying of food wastes.

Solutions for the removal of household wastes, more particularly kitchen wastes, are known in the art, wherein the waste to be handled is ground in a waste grinder, which is arranged in a kitchen in connection with the sink, and which conveys onwards the ground food wastes into the sewer piping. These solutions need an electricity connection for the waste grinder of each input location of wastes. In many countries the use of waste grinders connected to the sewer network is forbidden by regulations, because the arrangement increases, inter alia, the nutrient load in the sewage water.

Solutions are known in which foodstuffs and their wastes are conveyed in a dispensed manner from a feed-in station into a collection reservoir and possibly to further handling in piping by the aid of a pressure difference and/or suction. One such prior-art solution is known from patent publication US2006207653 A1. Extensive systems for the pneumatic conveying of wastes, wherein wastes are transferred in piping by means of suction, are known in the art. In these, wastes are conveyed long distances in the piping by sucking. The apparatuses are used for, among other things, the conveying of wastes in different institutions. It is typical to these systems that a partial-vacuum apparatus is used to achieve a pressure difference, in which apparatus a partial vacuum is achieved in the conveying pipe with partial-vacuum generators, such as with vacuum pumps or with an ejector apparatus. A conveying pipe typically comprises at least one valve means, by opening and closing which the replacement air coming into the conveying pipe is regulated. In prior-art systems there is a problem, among others, in that complex control systems and/or electrical current are typically needed in their input points, in which case installation of the systems is awkward and demands diversified professional expertise.

The aim of the present invention is to achieve a new type of solution in connection with material conveying systems, by means of which solution the drawbacks of prior art solutions are avoided. Another aim of the invention is to achieve a solution applicable to partial-vacuum transfer systems, by the aid of which the installation work of the systems, and the professional expertise needed in said work, can be facilitated.

### BRIEF DESCRIPTION OF THE INVENTION

The invention is based on a concept wherein water and normal water mains pressure is used as a medium of, and for the control of, the actuator of a shut-off valve that is in connection with an input point of material.

The method according to the invention is characterized by what is disclosed in the characterization part of claim 1.

The method according to the invention is also characterized by what is stated in claims 2-11.

The apparatus according to the invention is characterized by what is disclosed in the characterization part of claim 12.

The apparatus according to the invention is also characterized by what is stated in claims 13-23.

The solution according to the invention has a number of important advantages. The solution according to the invention is easy to install and use, because the input point does not need electricity or means for conveying control commands from the input points to a central unit, or from a central unit to the input points, in order to operate. The system can thus be installed in all apartments that contain a water pipe. The input point can thus be easily installed by simply a plumbing installation person. The solution according to the invention allows the collection and conveying of food wastes directly from the kitchen. The method and apparatus according to the invention use considerably less water than a waste grinder, the wastes of which are conducted into the sewer. By means of the invention the conveying of food wastes into a waste bin can be effectively solved. The arrangement according to the invention is applicable in buildings and vessels of very many types.

### BRIEF DESCRIPTION OF THE FIGURES

In the following, the invention will be described in more detail by the aid of an example of its embodiment with reference to the attached drawings, wherein

FIG. 1 presents as a diagram one system according to an embodiment of the invention,

FIG. 2 presents a simplified cross-section of a detail of a system of an embodiment of the invention, in a first operating phase,

FIG. 3 presents a cross-section of a detail of a system of an embodiment of the invention, in a second operating phase,

FIG. 4 presents a simplified detail of a system of a second embodiment of the invention,

FIG. 4a presents a detail from the direction A of FIG. 4,

FIG. 4b presents a B-B cross-section of FIG. 4a,

FIG. 5 presents a simplified detail of a system of a third embodiment of the invention,

FIG. 6a presents a detail of an embodiment of a system according to the invention, in a first operating phase, and

FIG. 6b presents a detail of an embodiment of a system according to the invention, in a second operating phase.

### DETAILED DESCRIPTION OF THE INVENTION

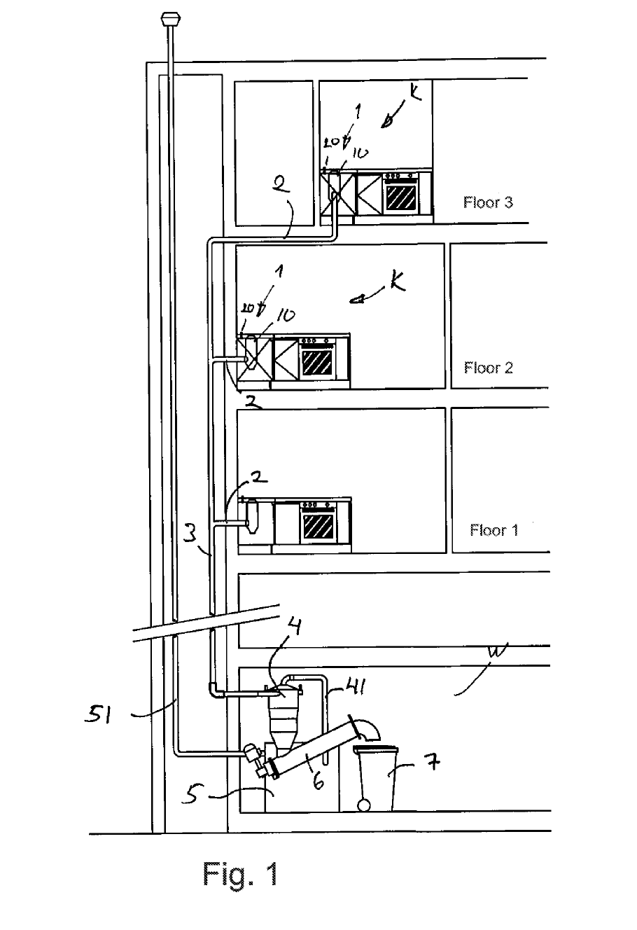

FIG. 1 presents a simplified diagram of a pneumatic material conveying system according to one embodiment according to the invention, more particularly a kitchen wastes conveying system. The figure presents a part of a building and of the residential floors Floor1, Floor2, Floor3 of it. There are typically a number of apartments, such as residential apartments, on the floors, which apartments comprise a kitchen space K. A waste space W is in the bottom part of the building. A conveying system of kitchen waste is arranged in the building, which system comprises an input point 1 arranged in the kitchen of each apartment, conveying piping 2, 3, along the side of which at least one, typically many, input points 1 are arranged. An input point 1 is a feed-in station of material, more particularly of waste material, intended to be conveyed, from which station the material, more particularly waste material, such as kitchen waste, intended to be conveyed is fed into the conveying system. A partial-vacuum generator 5 is arranged in the waste room W, which partial-vacuum generator is connected via a separating device 4 to conveying piping 2, 3. In the separating device 4 the material to be conveyed in the conveying piping 3 is separated from the conveying air. Typically conveying piping comprises a main conveying pipe 3, to which it has been possible to connect a number of branch conveying pipes 2 and to each of which branch conveying pipes it, has been possible to connect a feed-in station 1. The material fed in is transferred along the conveying piping 3 to a separating device 4, in which the material being conveyed is separated, e.g. due to the dropping of speed and due to centrifugal force, from the conveying air. The separated material is removed, e.g. according to need, from the separating device 4, e.g. with a worm conveyor 6, to a material container, such as to a waste container 7, or to further handling. A conveying air duct 41 leads from the separating device 4 to the means 5 for forming a partial vacuum in the conveying pipe. By the aid of the means for forming a partial vacuum the partial vacuum needed in conveying material is achieved in the conveying piping 3 and/or in a part of it. In the figure an exhaust air duct 51 from the partial-vacuum unit 5 is presented, which exhaust air duct is conducted outwards in the embodiment of the figure, e.g. to the roof of the building. The material can also be conducted, instead of into a waste bin 7, directly into a more extensive conveying system of material, e.g. into a MetroTaifun® waste-conveying system.

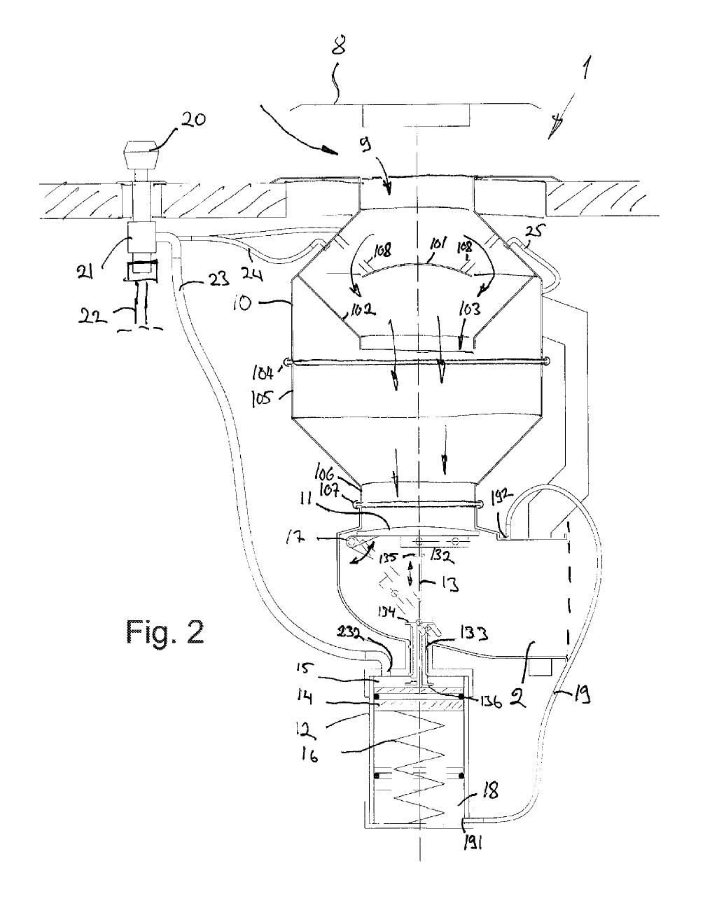

FIG. 2 presents in more detail one input point 1 to be used in a system according to the invention.

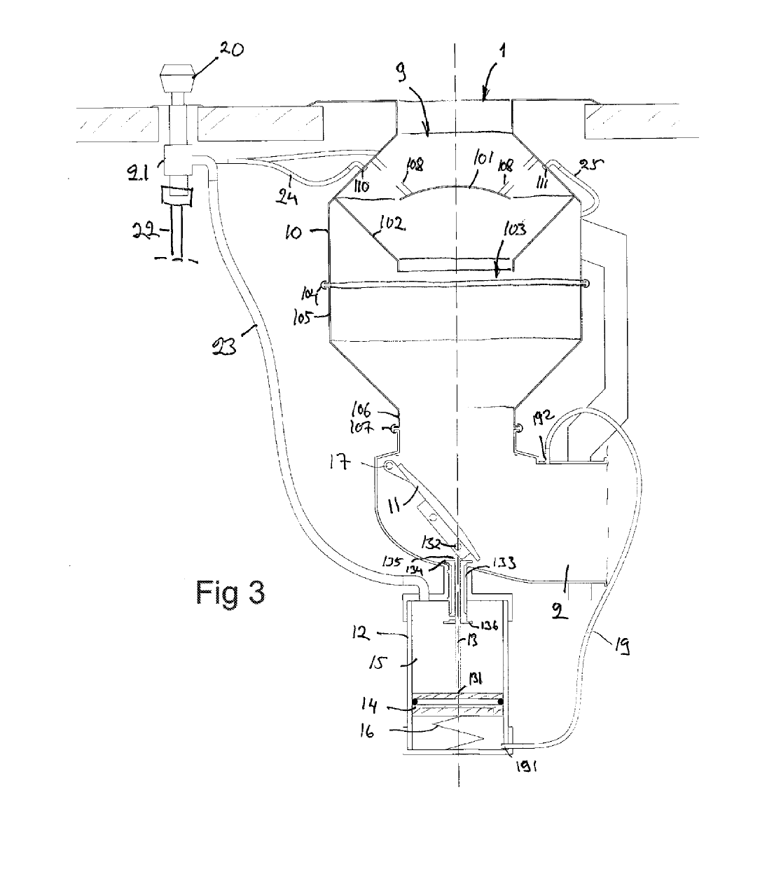

The input point 1 in the embodiment of the figure comprises an input aperture 9, from which material is fed into the feed-in container 10. The feed-in container 10 is connected from its bottom part 107 to an input pipe 2. A valve means 11 is arranged between the bottom part of the feed-in container and the input pipe 2, which valve means is driven by an actuator 12. The valve means 11, i.e. the discharge valve, in the closed position (FIG. 2) blocks the effect of the partial vacuum acting in the conveying piping 2, 3 on the feed-in receptacle and blocks the access into the conveying piping 2, 3 of material fed into the feed-in container. The discharge valve is driven by the actuator 12. The actuator 12 in the figure is a cylinder-piston unit, the rod of the piston of which is fixed at its first end 131 (seen in FIG. 3) to a piston 14 moving in a cylinder space 15, 18 and at its second end 132 to a discharge valve means 11. The valve means 11 is arranged to turn around an axis 17, in which case it can be moved from the closed position of FIG. 2 to the open position of FIG. 3.

The actuator 12 is driven with a pressure medium, which in the embodiment of the figures is water. In the embodiment of the figure, the actuator 12 comprises a spring means 16, which is arranged in the cylinder space 18. A medium pathway 23 is arranged in the cylinder space 15 on the opposite side of the piston 14, with respect to the spring means 16, which medium pathway can be connected to a water pipe 22. In the embodiment of the figure a dispensing device 20, 21 is used, pressing a button 21 in which device opens the medium pathway 23 from the water pipe 22 into the cylinder space 15. The dispensing device 20, 21 can be a normal, preferably adjustable, self-closing water tap. The medium pathway 23 is, according to FIG. 2, connected at its lower end 232 to the cylinder space 15 of the actuator 12.

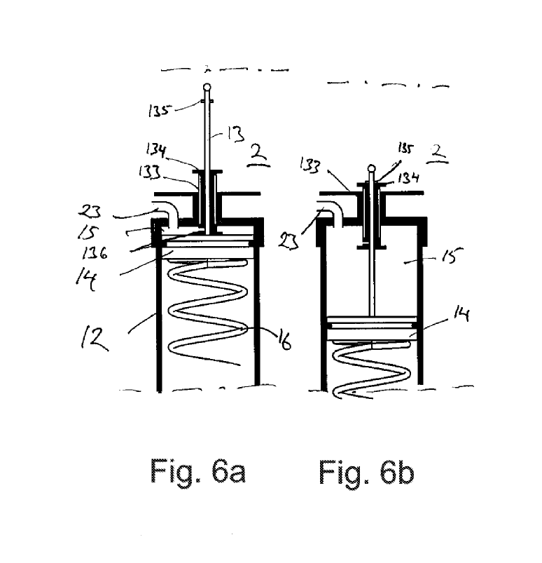

When the medium pathway is opened the piston starts to move, downwards in FIG. 2, against the direction of action of the spring 16 and the valve 17 opens (FIG. 3). This can be achieved with normal water mains pressure. Correspondingly, from the situation of FIG. 3, when the medium pathway 23 from the water pipe 22 into the cylinder space 15 is closed, the piston starts to move, upwards in FIG. 3, under the effect of the spring 16 and the valve 11 closes. The water that has acted in the cylinder space 15 is able to pass along the medium pathway 133 into the input pipe 2 and onwards into the conveying pipe 3. The opening and closing of the medium pathway 133 is explained hereinafter in connection with FIGS. 6a and 6b.

According to the embodiment of the invention, flushing lines 24, 25 are arranged into the feed-in container 10 from the water pipe 22, most suitably from a dispensing device 21. In this case flushing water is able to flush the inside surface of the feed-in container 10 from apertures 110, 111 formed in the wall of the container.

The feed-in container 10 is shaped in the embodiment of the figure to diverge after the input aperture 9, e.g. into a truncated cone-shaped section. The input aperture is shaped or fitted to be such that the size of the waste to be fed into the system can be fitted on the basis of the size of the whole input aperture 9. The discharge valve and conveying piping are fitted to convey a piece of material at least the size of that which can be fed into the system from the input aperture. In the embodiment of the figure a guide plate 101 that is mainly transverse with respect to the direction of the input aperture is arranged in connection with the input aperture, at a distance downwards from the top edge of the input aperture 9, e.g. resting on support parts 108, which guide plate guides the waste to be fed in from the input aperture sidewards in the diverging section of the feed-in container. After this the feed-in container comprises on the inside a converging section 102 of a truncated cone shape, which comprises an outlet aperture 103. The bottom part 105 of the feed-in container is arranged, in the embodiment of the figure, to be detachable with connection parts 104, 107. The bottom part 106 of the feed-in container is fixed with a connection part 107 to a section leading to the input pipe 2, in which section a valve means 11 is arranged. The feed-in container can be opened, preferably without tools, for cleaning.

A lid means 8 is in connection with the input point 1, which lid part can be separate or a lid means hinged on the top part of the feed-in container or in the proximity of it. The apparatus can be provided with safety locking, which prevents emptying of the feed-in container unless the lid 8 is placed into position.

The input aperture 9 of the input point is arranged, in the embodiment of the figure, on a worktop surface, such as into an aperture arranged in a kitchen tabletop, most suitably flush with the surface of the table. The means of an input point 1 are typically installed in kitchen furnishings.

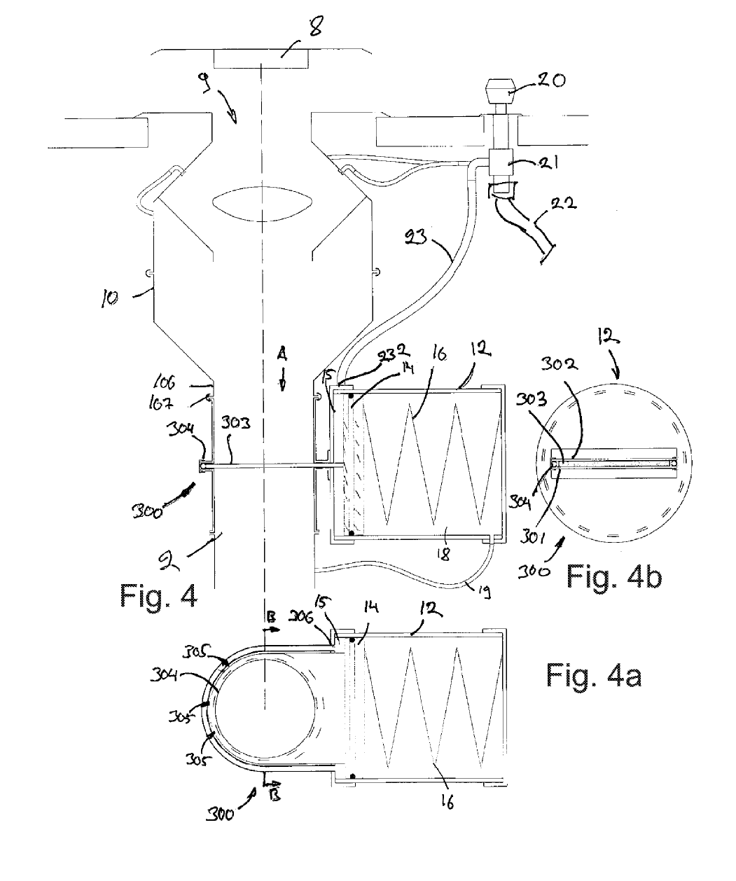

FIGS. 4, 4a and 4b present a second embodiment of the system according to the invention. A gate valve 300 has been applied in it as a valve means. The actuator 12 drives a plate-like closing means 303 to be moved between the walls 301, 302 of the body of the gate valve. In the first position the medium pathway from the feed-in container 10 into the input pipe 2 and onwards into the conveying piping 3 is closed and in the second position the medium pathway from the feed-in container into the input pipe 2 and onwards into the conveying piping 3 is open. The butt end part of the body of the gate valve is a pipe part 304, via which medium can be conducted into the space between the walls 301 and 302. There is an aperture 306 from the pipe-like part 304 of the butt end part into the cylinder space 15, from where the water to be used as a drive medium penetrates into the pipe-like part. Apertures 305 are formed in the pipe-like part, from which apertures water is able to travel into the space between the walls 301, 302 of the valve body and onwards via the access opening into the input pipe. The operation of the actuator is of the type described in connection with the previous embodiment. In FIG. 4 the valve is in the closed position. When it is desired to open the valve, the water dispensing button 20 is pressed down. The system feeds in water for the predefined period of time. The water also flushes the inside surface of the feed-in container via the pathways 24, 25. The water pressure moves the piston in the cylinder 15 to the right in the figure, towards the second position. The partial vacuum achieved by the partial-vacuum generator 5 acting in the conveying piping sucks the food wastes and water along with it. The waste travels under the effect of the partial vacuum, and possibly also of gravity, to the separator means 4 of the central unit along the piping.

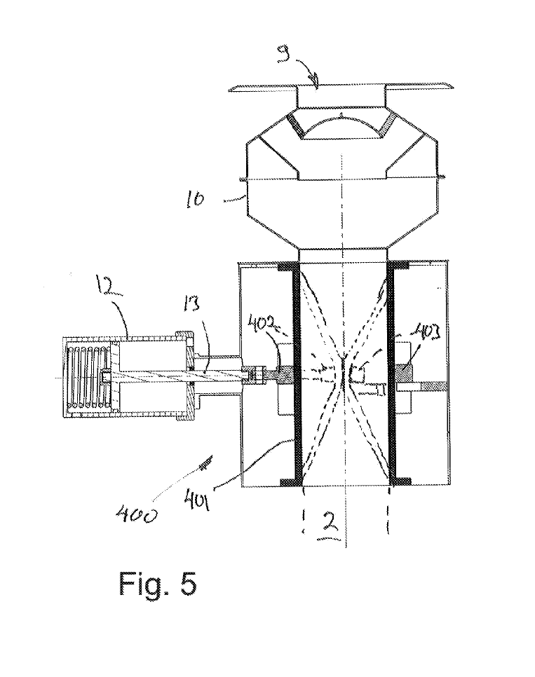

FIG. 5 presents yet another embodiment according to the invention. A pinch valve 400 is used as the valve means in it. Pinch valves are used generally in process industry pipelines as shut-off valves and/or control valves. When closing the valve 400 two parallel jaws 402, 403 moved by the actuator 12 press the hose 401 from two sides simultaneously, in which case the hose 401 is pressed closed, closing at the same time the flow in the piping.

The flexible hose 401 is most usually manufactured from rubber, inside which are reinforcements, typically textile layers. These reinforcement layers form the pressure-bearing part of the hose and the number of the layers depends on the pressure class of the hose. The inside rubber layer of the hose forms a sealing zone when the valve closes and the layer also protects the reinforcement layers against the wearing and chemical effect of the flowing substance. The rubber layer on the outer surface protects the reinforcement layers from wear caused by the jaws.

With the actuator 12 the compression parts 402, 403 of the pinch valve are acted upon, which compression parts in the first position press together the wall of the pathway of the hose part of the pinch valve such that the pathway from the feed-in container 10 is closed, and in the second position they release the compression, in which case the pathway from the feed-in container 10 into the input pipe 2 and onwards into the conveying piping 3 is open.

FIGS. 6a and 6b further present an arrangement in connection with the actuator, in respect of the discharge valve of the drive medium. A medium pathway 133 from the cylinder space 15 of the actuator 12 into the discharge pipe 2 can be opened and closed. The medium pathway is arranged in the figure in the sleeve part 134, which in FIG. 6a is in the first position (medium pathway from the cylinder space 15 into the discharge pipe 2 closed). When the drive medium, i.e. water, is conducted along the pathway 23 into the cylinder space 15, the piston 14 and the piston rod 13 start to move downwards in FIG. 6a. The piston rod comprises an extension part 135, such as a pin, which is fitted at the desired distance from the sleeve means 134. When the piston moves downwards (towards the position of FIG. 6b) the sleeve part 134 stays in its position and the pathway 133 is closed until the extension part 135 of the piston rod touches the sleeve part 134 and moves it downwards along with it. In this case the medium pathway 133 opens and water is able to escape from the cylinder space 15. This solution at least increases the seepage flow of water from the cylinder space 15 into the discharge pipe and thus speeds up the operation of the actuator and, for its part, saves water. When the spring 14 moves the piston upwards the medium pathway 133 remains open until the piston 14 touches the sleeve part 134 at the piston end 136 of it and moves the sleeve part to a position in which the medium pathway 133 is closed.

The embodiment of the figures also comprises a second medium pathway 19, which has a first end 191 and a second end 192, from the cylinder space 18 on the spring 16 side into the discharge pipe. In this case possible seepage water is able to move into the discharge pipe 2.

The invention thus relates to a method in a pneumatic material conveying system, such as in a waste conveying system, which conveying system comprises at least one input point 1 of material, more particularly of waste material, a material conveying pipe 2, 3, which can be connected to an input point 1, and a separating device 4, in which the material to be transferred is separated from the conveying air, and also means 5 for achieving a pressure difference in the conveying pipe 2, 3 at least during the transfer of material. The actuator 12 of the valve means 11, 300, 400 arranged between an input point 1 and the conveying piping 2, 3 is driven and/or controlled with water to be conducted from the water mains network 22.

According to one embodiment the actuator 12 is a cylinder-piston unit, the piston part 14 of which is moved from a first position to a second position by water to be conducted into the cylinder space 15.

According to one embodiment the actuator is a cylinder-piston unit, the piston part of which is moved from the second position to the first position by a spring means 16.

According to one embodiment the pressure medium to be used in moving the piston 14 of the actuator is conducted, at least when moving the piston from the second position to the first position, from the cylinder space 15 along the medium pathway 133 into the discharge pipe 2 or into the sewer.

According to one embodiment a hinged flap 11 is used as the valve means, which flap the piston rod 13 of the actuator is fitted to move.

According to one embodiment a gate valve is used as the valve means 300, the closing means 303 of which the piston 14 of the actuator is fitted to move.

According to one embodiment a pinch valve is used as the valve means 400, the compression means 402, 403 of which the piston rod 13 of the actuator is fitted to move.

According to one embodiment in the method a partial vacuum is achieved in the conveying pipe 3 with at least one partial-vacuum generator 5, the suction side of which is connected to a separating means 4 or to a conveying pipe 3 leading to it via an air duct 41.

According to one embodiment the valve means 11, 300, 400, i.e. the discharge valve, is controlled manually with a drive device 20, 21 or in a manner through connection to a lid means 8.

According to one embodiment the inside surface of the feed-in container 10 is flushed with water at least during the emptying.

According to one embodiment in the method material is fed in from the input points 1, which are arranged for each specific apartment, most suitably in the kitchen space K, in which case the material to be conveyed is most suitably food waste.

The invention also relates to an apparatus in a pneumatic material conveying system, such as in a waste conveying system, which conveying system comprises at least one input point 1 of material, more particularly of waste material, a material conveying pipe 2, 3, which can be connected to an input point 1, and a separating device 4, in which the material to be transferred is separated from the conveying air, and also means 5 for achieving a pressure difference in the conveying pipe 2, 3 at least during transfer of material. The drive medium and/or control medium of the actuator 12 of the valve means 11, 300, 400 arranged between an input point 1 and the conveying piping 2, 3 is water to be conducted from the water mains network 22.

According to one embodiment the actuator 12 is a cylinder-piston unit, the piston part 14 of which is fitted to be moved from a first position to a second position by water to be conducted along the medium pathway 23 into the cylinder space 15.

According to one embodiment the actuator 12 is a cylinder-piston unit, the piston part 14 of which is fitted to be moved from the second position to the first position by a spring means 16.

According to one embodiment the apparatus comprises a medium pathway 133 from the cylinder space 15 into the discharge pipe 2 or into the sewer.

According to one embodiment the apparatus comprises a dispensing device 20, 21, for opening the medium pathway 23 from the water pipe 22 into the cylinder space 15.

According to one embodiment the dispensing device 20, 21 is a, preferably adjustable, self-closing water tap.

According to one embodiment the valve means 11 is a hinged flap, which the piston rod 13 of the actuator is fitted to move.

According to one embodiment the valve means 300 is a gate valve, the closing means 303 of which the piston 14 of the actuator is fitted to move.

According to one embodiment the valve means 400 is a pinch valve, the compression means 402, 403 of which the piston rod 13 of the actuator is fitted to move.

According to one embodiment the apparatus comprises at least one partial-vacuum generator 5, the suction side of which is connected to a separating means 4 or to a conveying pipe 3 leading to it via an air duct 41.

According to one embodiment the apparatus comprises means 24, 25, 110, 111 for flushing the inside surface of the feed-in container 10 with water.

According to one embodiment an input point 1 is arranged in the building for each specific apartment, most suitably in the kitchen area K of the apartment.

The means for achieving a pressure difference comprise at least one pump device, such as a partial-vacuum generator 5 and/or a fan, the suction side of which is connected to a separating means 4 or to an air duct leading to it.

The discharge valve 11, 300, 400 of an input point 1 is opened and closed such that material batches of a suitable size are conveyed from the input point 1 into the conveying pipe 2, 3. Material is fed in from an input point 1, the lid 8 is placed on top of the input aperture 9 of the input point and the discharge valve 11 is opened. The operating medium of the actuator 12 of the discharge valve 11 is at least partly water, which is brought from a water pipe 22, with the pressure of the water mains network. In the embodiment of the figures, the operating switch 20 (dispensing button) of the water dispensing means is pressed downwards, in which case

It is assumed that the aim is to empty the feed-in container 10 of the input point 1 belonging to the circuit of the conveying pipe 3. The discharge valve 11, 300, 400 opens, depending on the components of the apparatus that are used, momentarily, e.g. for 2-10 seconds, in which case the material, such as waste material, to be conveyed transfers under the effect of the partial vacuum from the feed-in container 10 via the input pipe 2 into the conveying pipe 3 and onwards into the separating device 4. The discharge valve 11, 300, 400 is closed typically a few seconds after the start situation. The vacuum pump unit 5 maintains the desired partial vacuum.

From the separating device 4 the material is conveyed with conveying means 6, such as with a worm conveyor, into the container 7.

The container 7, such as a waste bin, is exchanged or replaced when it fills up. The system can also comprise a number of separating devices 4, into which conveyance of material is guided e.g. according to the type of material or on the basis of the capacity of the system.

It is obvious to the person skilled in the art that the invention is not limited to the embodiments presented above, but that it can be varied within the scope of the claims presented below. The characteristic features possibly presented in the description in conjunction with other characteristic features can, if necessary, also be used separately to each other.

1. Method in a pneumatic material conveying system, such as in a waste conveying system, which conveying system comprises at least one input point (1) of material, more particularly of waste material, a material conveying pipe (2, 3), which can be connected to an input point (1), and a separating device (4), in which the material to be conveyed is separated from the conveying air, and also means (5) for achieving a pressure difference in the conveying pipe (2, 3) at least during the transfer of material, characterized in that the actuator (12) of the valve means (11, 300, 400) arranged between an input point (1) and the conveying piping (2, 3) is driven and/or controlled with water to be conducted from the water mains network (22).

2. Method according to claim 1, characterized in that the actuator (12) is a cylinder-piston unit, the piston part (14) of which is moved from a first position to a second position by water to be conducted into the cylinder space (15).

3. Method according to claim 1, characterized in that the actuator is a cylinder-piston unit, the piston part of which is moved from the second position to the first position by a spring means (16).

4. Method according to any of claim 1, characterized in that the pressure medium to be used in moving the piston (14) of the actuator is conducted, at least when moving the piston from the second position to the first position, from the cylinder space (15) along the medium pathway (133) into the discharge pipe (2) or into the sewer.

5. Method according to claim 1, characterized in that a hinged flap (11) is used as the valve means, which flap the piston rod (13) of the actuator is fitted to move.

6. Method according to claim 1, characterized in that a gate valve is used as the valve means (300), the closing means (303) of which the piston (14) of the actuator is fitted to move.

7. Method according to claim 1, characterized in that a pinch valve is used as the valve means (400), the compression means (402, 403) of which the piston rod (13) of the actuator is fitted to move.

8. Method according to claim 1, characterized in that in the method a partial vacuum is achieved in the conveying pipe (3) with at least one partial-vacuum generator (5), the suction side of which is connected to a separating means (4) or to a conveying pipe (3) leading to it via an air duct (41).

9. Method according to claim 1, characterized in that the valve means (11, 300, 400), i.e. the discharge valve, is controlled manually with a drive device (20, 21) or in a manner through connection to a lid means (8).

10. Method according to claim 1, characterized in that the inside surface of the feed-in container (10) is flushed with water at least during the emptying.

11. Method according to claim 1, characterized in that in the method material is fed in from the input points (1), which are arranged for each specific apartment, most suitably in the kitchen space (K), in which case the material to be conveyed is most suitably food waste.

12. Apparatus in a pneumatic material conveying system, such as in a waste conveying system, which conveying system comprises at least one input point (1) of material, more particularly of waste material, a material conveying pipe (2, 3), which can be connected to an input point (1), and a separating device (4), in which the material to be transferred is separated from the conveying air, and also means (5) for achieving a pressure difference in the conveying pipe (2, 3) at least during the transfer of material, characterized in that the drive medium and/or control medium of the actuator (12) of the valve means (11, 300, 400) arranged between an input point (1) and the conveying piping (2, 3) is water to be conducted from the water mains network (22).

13. Apparatus according to claim 12, characterized in that the actuator (12) is a cylinder-piston unit, the piston part (14) of which is fitted to be moved from a first position to a second position by water to be conducted along the medium pathway (23) into the cylinder space (15).

14. Apparatus according to claim 12, characterized in that the actuator (12) is a cylinder-piston unit, the piston part (14) of which is fitted to be moved from the second position to the first position by a spring means (16).

15. Apparatus according to claim 12, characterized in that the apparatus comprises a medium pathway (133) from the cylinder space (15) into the discharge pipe (2) or into the sewer.

16. Apparatus according to claim 12, characterized in that the apparatus comprises a dispensing device (20, 21), for opening the medium pathway (23) from the water pipe (22) into the cylinder space (15).

17. Apparatus according to claim 16, characterized in that the dispensing device (20, 21) is a, preferably adjustable, self-closing water tap.

18. Apparatus according to claim 12, characterized in that the valve means (11) is a hinged flap, which the piston rod (13) of the actuator is fitted to move.

19. Apparatus according to claim 12, characterized in that the valve means (300) is a gate valve, the closing means (303) of which the piston (14) of the actuator is fitted to move.

20. Apparatus according to claim 12, characterized in that the valve means (400) is a pinch valve, the compression means (402, 403) of which the piston rod (13) of the actuator is fitted to move.

21. Apparatus according to claim 12, characterized in that the apparatus comprises at least one partial-vacuum generator (5), the suction side of which is connected to a separating means (4) or to a conveying pipe (3) leading to it via an air duct (41).

22. Apparatus according to claim 12, characterized in that the apparatus comprises means (24, 25, 110, 111) for flushing the inside surface of the feed-in container (10) with water.

23. Apparatus according to claim 12, characterized in that an input point (1) is arranged in the building for each specific apartment, most suitably in the kitchen area (K) of the apartment.
